(19) United States
(12) Patent Application Publication
(10) Pub. No.: US 2007/0050709 A1
(43) Pub. Date: Mar. 1, 2007

(54) Character input aiding method and information processing apparatus

(75) Inventor: Koji Inose, Saitama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/504,605

(22) Filed: Aug. 16, 2006

(30) Foreign Application Priority Data
Aug. 23, 2005 (JP) 2005-241560

(51) Int. Cl. G06F 17/00

(52) U.S. Cl. 715/517

(57) ABSTRACT

When a character string constructed with words which are separated by a predetermined letter symbol is input and confirmed, a set of words is registered in a memory, which has, as elements, all words included in the input character string. Meanwhile, with respect to a character string being inputted, a set of words including an exact-match word or a partial-match word of the character string is acquired from the set of words registered in the memory. A supplement candidate character string of the character string being inputted is generated based on the acquired set of words, and exhibited to a user. Thus, upon input operation of a character string, the burden on the user can be reduced.

### BACKGROUND OF THE INVENTION

1. Field of the Invention

The present invention relates to an apparatus, a method, and an execution program for aiding a character input operation using a character input device, e.g., a keyboard, by supplementing characters.

2. Description of the Related Art

Generally there are a large number of application programs that provide a field for text input. For instance, in a web browser, a text input field can be arranged in a web page for the purpose of inputting a search term. In such search input, one often inputs the same search term as that has been inputted in the past. Therefore, there is a technique proposed for aiding the input based on the input history.

For instance, in a case where a user accesses a search site using a web browser, the user can designate plural search terms as a character string (will be referred to as a space separation character string), where the search terms are connected with space characters. The web browser stores the space separation character string as the input history. When a new character string is inputted, the web browser supplements the character being inputted based on the space separation character string stored as the input history, and exhibits to the user a complete space separation character string as an input candidate.

Besides, there is another supplementing technique upon designating a partial character string of a single word or the beginning of a phrase, the rest of the partial character string is supplemented based on the history. This technique is characterized by realizing input aid with the method of giving a difference between the supplement portion exhibiting method and the display portion exhibiting method. The typical example of such technique is disclosed in Japanese Patent Application Laid-Open (KOKAI) No. 2002-099375.

However, in the above-described supplementing function of the conventional art, the entire space separation character string is treated as one object for supplement processing. To utilize the aforementioned supplementing function in an input operation on a search field or the like, a user must input the partial character string from the beginning (will be referred to as a head character string) of the space separation character string inputted in the past. In general, a user inputs plural search terms in random order. Therefore, it is often difficult to input in the same order the words of the space separation character string inputted in the past. In other words, such operational limitation, which requires a user to remember a search term that has happened to be input first in a past input operation and to start the search input from that term, is a great burden to the user.

The above operation is now described with reference to FIG. 1. Numerals 101 and 102 in FIG. 1A denote input history of space separation character strings. As shown in FIG. 1B, when “digi” is inputted to the input field 111, the space separation character strings 101 and 102 in the input history are extracted as a result of a beginning-match comparison and displayed as supplement candidates 121 and 122. When “tal model6” is subsequently inputted in the input field 111, beginning-match comparison is performed using the character string “digital model6”, and only the space separation character string 101 in the input history is extracted. As a result, the supplement candidate 121 only is displayed as shown in FIG. 1C. In this manner, supplement candidates are narrowed down.

On the contrary, if “resolution” is inputted in the input field 111 as shown in FIG. 1D, both the space separation character strings 101 and 102 in the input history do not have a matching head character string. In other words, there is no space separation character string extracted by the beginning-match comparison. In this case, since there is no supplement candidate, a blank field 131 is displayed. Also, as shown in FIG. 1E, in the case where “tal reso” is inputted in the input field 111 subsequent to the state in FIG. 1B, both the space separation character strings 101 and 102 in the input history do not have a matching head character string. Therefore, since there is no supplement candidate, the supplement candidates that were displayed in the stage of FIG. 1B disappear, and a blank field 131 is displayed.

As described above, although the conventional art reduces the burden of an input operation by exhibiting supplement candidates, if the order of words is different from the one inputted in the past, the intended supplement candidate cannot be obtained. Furthermore, although the conventional art has made suggestions to facilitate a selection operation of the supplement results or the like, there are still remaining problems regarding the above-described operational limitation (an input order of words has to be matched exactly).

### SUMMARY OF THE INVENTION

The present invention has been made in view of the above-described problem, and has as its object to reduce user's burden in a character-string input operation.

According to one aspect of the present invention there is provided a character input aiding method in an information processing apparatus capable of inputting a character string constructed with plural words, comprising: a registration step of registering a set of words in a memory, the set of words having as elements all words included in a character string which has been inputted to the information processing apparatus and confirmed; an acquisition step of acquiring, from the set of words registered in the registration step, a set of words including an exact-match word or a partial-match word of a character string being inputted to the information processing apparatus; and a generation step of generating a supplement candidate character string based on the set of words acquired in the acquisition step and exhibiting the supplement candidate character string.

According to another aspect of the present invention there is provided an information processing apparatus capable of inputting a character string constructed with plural words, comprising: a registration unit that registers a set of words in a memory, the set of words having as elements all words included in a character string which has been inputted to the information processing apparatus and confirmed; an acquisition unit that acquires, from the set of words registered by the registration unit, a set of words including an exact-match word or a partial-match word of a character string being inputted to the information processing apparatus; and a generation unit that generates a supplement candidate character string based on the set of words acquired by the acquisition unit and exhibits the supplement candidate character string.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A to 1E are explanatory views of general display operation of supplement candidate character strings;

FIG. 2 is a view showing a configuration of an information processing apparatus according to an embodiment;

FIG. 3 is a table showing a data construction example of a word list table;

FIG. 4 is a table showing a data construction example of a word table;

FIG. 5 is a flowchart describing input history data registration processing according to the first embodiment;

FIG. 6 is a flowchart describing generation and display processing of a word supplement character string according to the first embodiment;

FIG. 7A to 7C are views of display operation of a supplement candidate character string according to the first embodiment;

FIG. 8 is a flowchart describing narrow-down processing of supplement candidate character strings according to the second embodiment;

FIG. 9 is a view showing an example of input history data for explaining an operation of the second embodiment;

FIGS. 10A to 10C are views of display operation of a supplement candidate character string according to the second embodiment; and

FIG. 11 is a flowchart describing narrow-down processing of a supplement candidate character string according to the third embodiment.

### DESCRIPTION OF THE EMBODIMENTS

Preferred embodiments of the present invention will now be described in detail in accordance with the accompanying drawings.

### First Embodiment

[Apparatus Configuration]

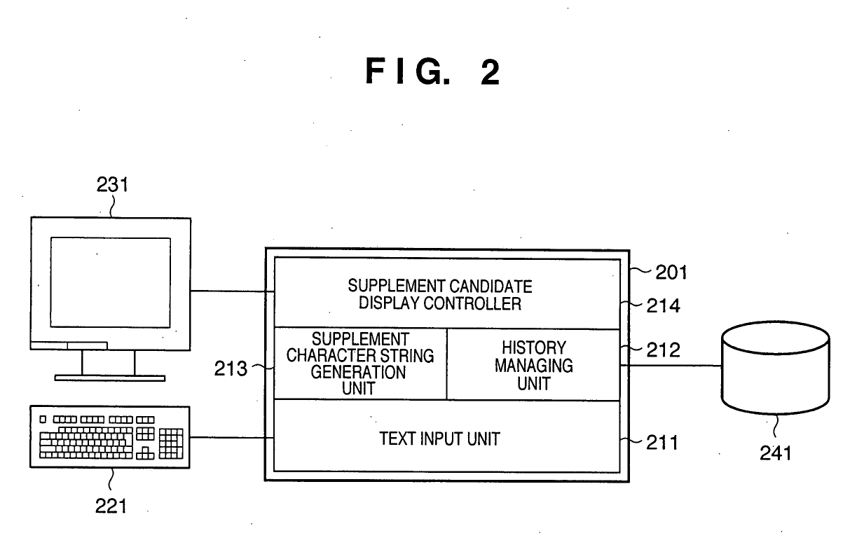

FIG. 2 is a view showing a configuration of an information processing apparatus according to the first embodiment. A computer 201, comprising a CPU, RAM and ROM that are not shown as well as an external storage device 241 (e.g., hard disk) and so on, realizes the functions represented by numerals 211 to 214 by the CPU executing a control program. Note that apparently a general-purpose computer, e.g., a personal computer, can be used as the computer 201.

The text input unit 211 receives texts inputted by a keyboard 221. A history managing unit 212 acquires a space separation character string inputted by the keyboard 221 through the text input unit 211, and stores it as input history data in, e.g., the external storage device 241. The space separation character string is a character string formed with plural words separated by space. A character or a letter symbol other than space may be used for separating words. In other words, the space separation character string may be configured with plural words separated by a predetermined character or a letter symbol. Assume that the space separation character string includes a character string which is configured with one word and has no character to separate words. The supplement character string generation unit 213 generates a supplement character string of an inputted character string based on the character string inputted by the text input unit 211 and input history data managed by the history managing unit 212. The supplement candidate display controller 214 executes various displaying, including displaying of the supplement character string generated by the supplement character string generation unit 213.

Hereinafter detailed descriptions will be provided on supplement candidate display processing of the information processing apparatus having the above-described configuration.

[Registering Input History Data]

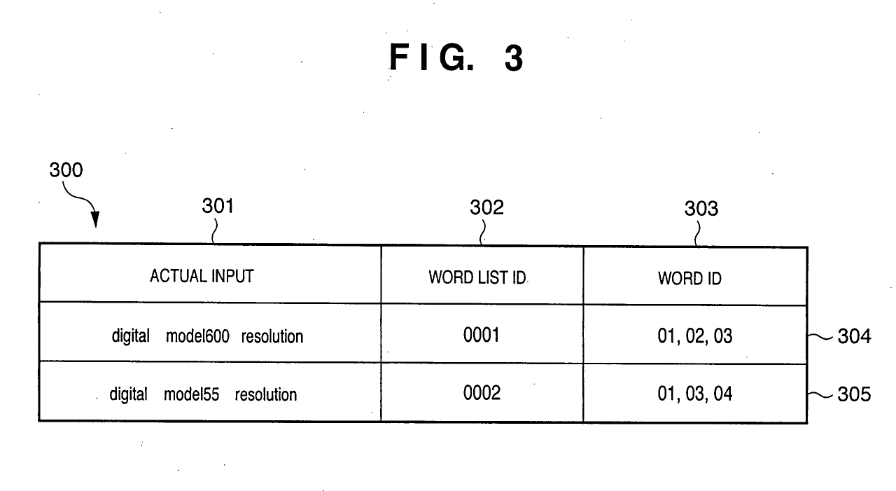

First described with reference to FIGS. 3 to 5 is an input history data registration procedure executed by the history managing unit 212.

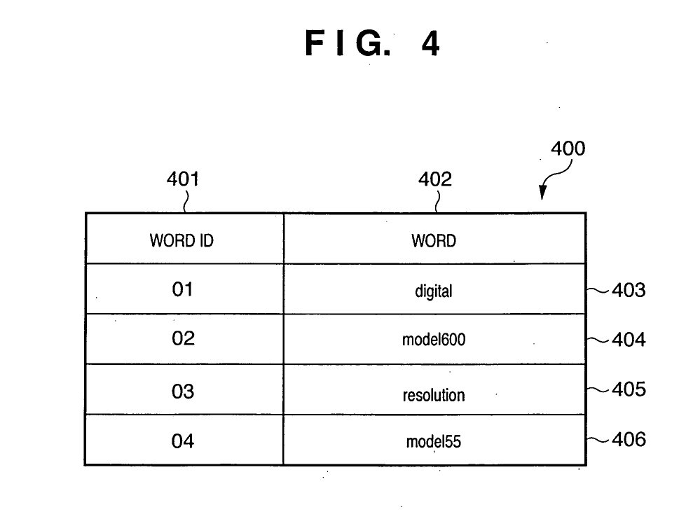

FIGS. 3 and 4 show examples of word list tables generated when the space separation character strings “digital model600 resolution” and “digital model55 resolution” are inputted. In the word list table 300 in FIG. 3, an actually inputted space separation character string is registered in the field 301. In the field 302, an ID which is assigned for managing the space separation character string as a set of words is registered. Hereinafter, a set of words obtained from one space separation character string will be referred to as a word list, and an ID assigned to the word list will be referred to as a word list ID. In the field 303, a word ID assigned to each word constituting the word list element is registered. The record 304 corresponds to the space separation character string “digital model600 resolution” and the record 305 corresponds to the space separation character string “digital model55 resolution”.

In the word table 400 in FIG. 4, a character string of each word constituting the inputted space separation character string is registered in the field 402, and a word ID of each word is registered in the field 401. Note that the word ID assigned in the word table 400 is registered in the word ID field 303 in FIG. 3. The records 403 to 406 show the registration state of the words constituting the space separation character strings that are registered in the records 304 and 305 in FIG. 3.

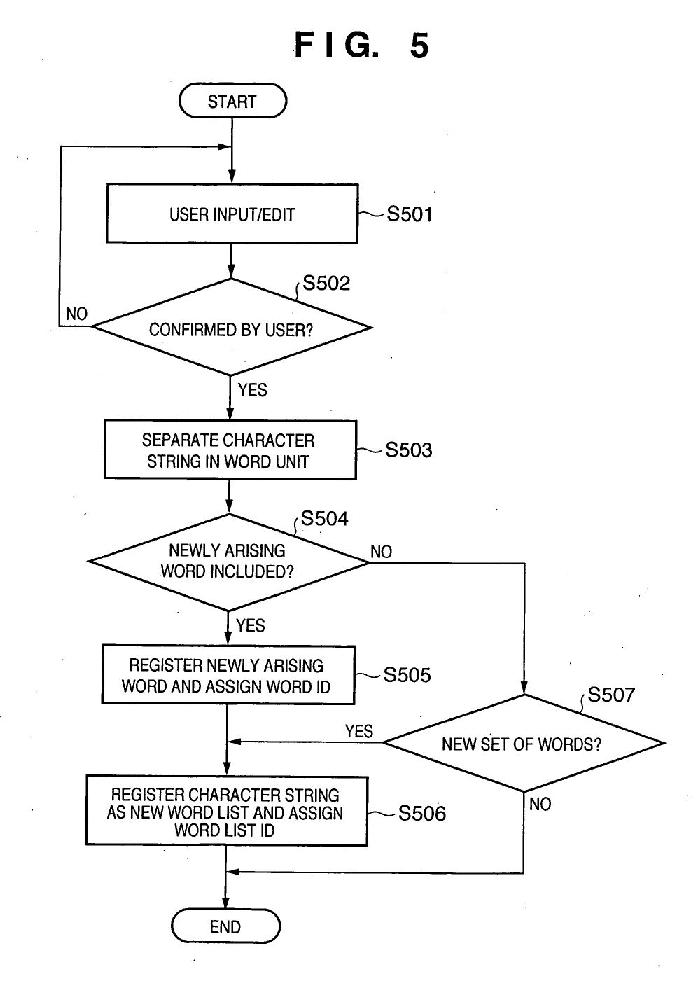

Next, input history data registration processing which is performed mainly by the history managing unit 212 is described with reference to FIG. 5. In step S501, a space separation character string inputted by a user in a predetermined field (e.g., a search-term input field) is received. In step S502, when a user's confirmation input is detected, predetermined processing using the inputted space separation character string (e.g., search processing) is performed. In parallel with the predetermined processing, input history data registration is performed. More specifically, the control proceeds from step S502 to S503 in response to the confirmation operation, and words are extracted from the space separation character string received in step S501 to obtain a set of words. Note that the word extraction can be realized by separating the space separation character string by the space. In step S504, it is determined with respect to each word of the set of words extracted in step S503 whether or not it has been registered in the word table 400.

If the set of words includes a word that has not been registered in the word table 400, it is determined that the set of words obtained in step S503 includes a newly arising word, and the control proceeds from step S504 to S505. In step S505, among the words constituting the set of words obtained in step S503, all the words that have not been registered in the word table 400 are extracted as newly arising words. Then, a word ID is assigned to each of the extracted newly arising words, and they are additionally registered in the word table 400. Further, in step S506, a word list ID is assigned to the space separation character string as a new word list, and registered in the word list table 300 together with IDs of the words constituting the space separation character string.

Meanwhile, if the set of words does not include a newly arising word in step S504, the control proceeds to step S507, and it is determined whether or not the same set of words (word list) as that acquired in step S503 has been registered in the word list table 300. If the word list table 300 has the same set of words, the control ends since the space separation character string has already been registered. If the word list table 300 does not have the same set of words, the control proceeds from step S507 to S506, and the set of words is additionally registered in the word list table 300 as a new word list.

In the foregoing manner, by inputting space separation character strings in the predetermined field, input history data (word list table 300 and word table 400) is generated.

For instance, in a case where “digital model600 resolution” has been registered in the word list table 300 (word IDs 01 to 03 are registered in the word table 400), assume that a space separation character string “digital model55 resolution” is inputted. In this case, since there is a word (model55) which does not exist in the word table 400, the control proceeds from step S504 to S505. In step S505, a word ID=04 is assigned to the newly arising word “model55”, and it is registered in the word table 400. As a result, the word table 400 has a content shown in FIG. 4. In step S506, a word list ID0002 is assigned to the space separation character string “digital model55 resolution” and it is registered in the word list table 300. In this stage, IDs are acquired from the word table 400 for the words included in the space separation character string, i.e., digital=01, model55=04, resolution=03, and registered in the word ID field 303. In this manner, the record 305 is added.

[Word Supplement Processing]

Next described is word supplement processing using the input history data (word list table 300 and word table 400) which is recorded in the foregoing manner.

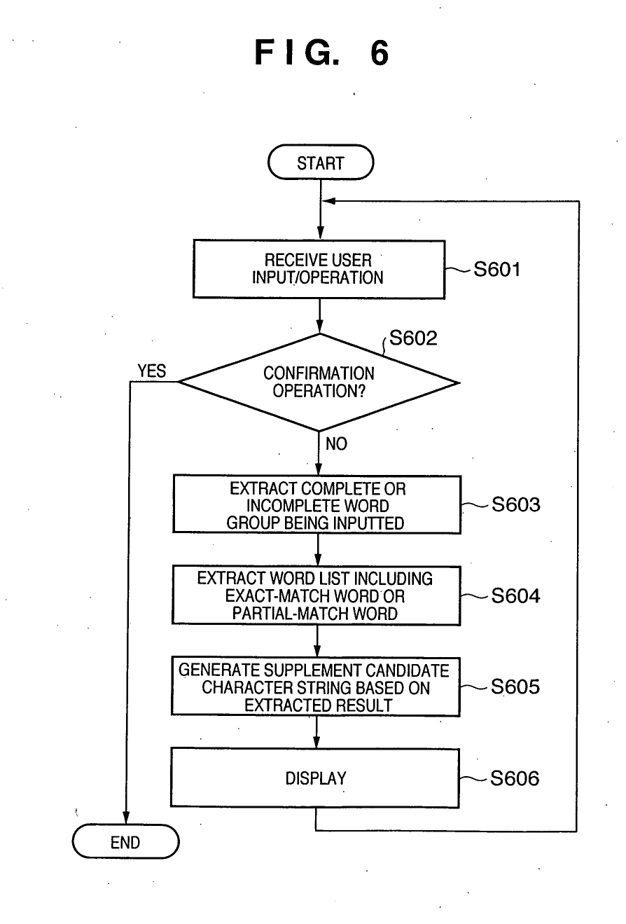

FIG. 6 is a flowchart describing the word supplement processing according to the present embodiment. This processing is performed by the supplement character string generation unit 213 and the supplement candidate display controller 214. In step S601, the supplement character string generation unit 213 receives user input. If the user input is “confirmation”, the control ends immediately after step S602. Note that the confirmation operation brings about predetermined processing using the space separation character string and the above-described input history data registration processing. If the user input is a character or a letter symbol, the control proceeds from step S602 to S603. In step S603, the supplement character string generation unit 213 extracts an incomplete or complete word from the character string being inputted, searches the word table 400 for an exact-match word or a partial-match word (beginning match), and extracts the corresponding word ID. Note that in a case where space is included, only an exact-match word is extracted with respect to a character string before the first space and a character string between spaces. In the foregoing manner, a word ID corresponding to each word of the word group, which has been extracted from the character string being inputted, is extracted. Herein, the word group extracted from a character string being inputted is a character string group which is clipped based on the space separation character.

In step S604, the supplement character string generation unit 213 extracts a word list ID that includes the word ID extracted in step S603. Note that the word list ID extracted here includes “word IDs of all words determined by a separation character (space)” and “a word ID of an exact-match or partial-match word (if there are plural words, one of them) of a character string yet to be determined as a word”. In step S605, the supplement character string generation unit 213 generates a supplement character string (generation of supplement character string will be described later) using a word list (a set of words) corresponding to the word list ID extracted in step S604. In step S606, the supplement candidate display controller 201 displays on a display 231 the supplement character string generated in step S605 as a supplement candidate.

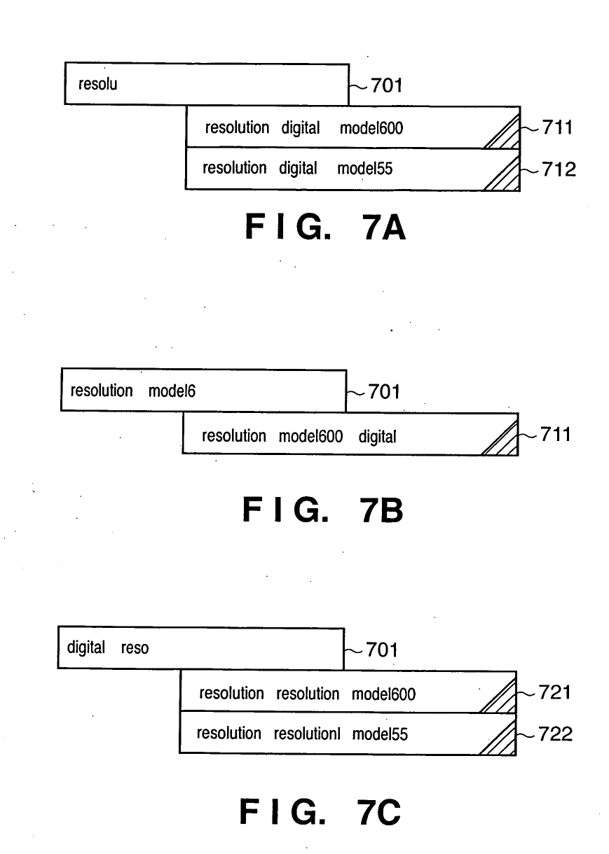

The word supplement processing is described using a specific example shown in FIG. 7. Assume that the word list table 300 shown in FIG. 3 and the word table 400 shown in FIG. 4 have already been formed as input history data.

Assume that text input (“resolu”) shown in FIG. 7A is performed in the input field 701. The word “resolution” which includes the character string “resolu” is extracted from the word table 400, and the word ID=03 is acquired (step S603). Then, a word list including the word ID=03 is searched in the word list table 300 in FIG. 3, and the word list IDs=0001 and 0002 are acquired (step S604). Among the words included in each word list, the beginning-matched word “resolution” is placed first, then the remaining elements of the set of words are subsequently placed using space as a separation character, thereby constructing a supplement character string (step S605). The supplement character string constructed in the foregoing manner is displayed on the display 231 as shown in supplement candidate display 711 and 712. Note in the construction of the supplement candidate character string in step S605, among the words included in the extracted word list, an exact-match word or a partial-match word is arranged in an order in the inputted character string, and the remaining words are arranged subsequently. Although the arrangement order of the remaining words is arbitrary, for instance, the words may be arranged in order of ID numbers.

Described next is a case where the user input is continuously performed and, for instance, “resolution mode” is inputted. Since “resolution” is confirmed as a word by space input, only an exact-match word (word ID=03) is acquired from the word table 400. Then, partial-match words (word ID=02, 04) of “mode” are acquired (step S603). In step S604, a word list including the word IDs=03 and 02 as well as a word list including the word IDs=03 and 04 are extracted. As a result, supplement candidates shown in FIG. 7A are displayed as similar to the above.

Assume that the user input is further continued, and “resolution model6” is inputted in the input field 701 in FIG. 7. In this case, since “resolution” is confirmed as a word by space input, only an exact-match word is extracted from the word table 400. Since “model6” is not confirmed as a word, exact-match or partial-match words are extracted from the word table. In this case, word IDs=03 and 02 are extracted from the word table 400. Thereafter, a word list including both word IDs=03 and 02 is extracted from the word list table 300. In this case, the word list ID=0001 is extracted, and displaying is performed based on the extracted result. As a result, only the supplement candidate 711 is displayed as shown in FIG. 7B.

When a user selects one of the exhibited supplement candidates (711 and 712 in FIG. 7), the selected content is set in the input field 701.

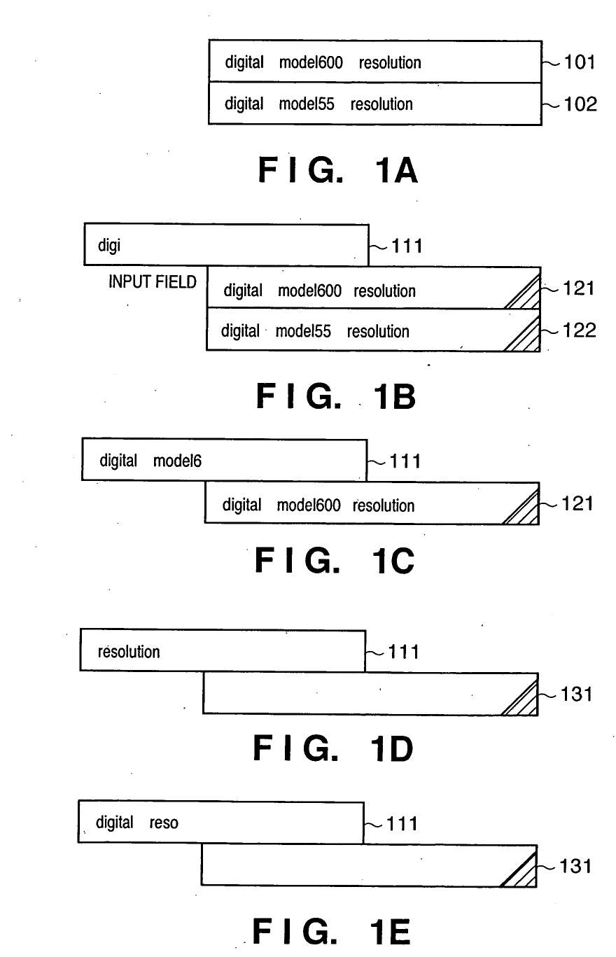

According to the foregoing processing, at the stage of inputting “digital reso” in the input field 701, a word list including the word IDs=01 and 03 is extracted. As a result, a supplement candidate character string 721 is displayed as shown in FIG. 7C. Therefore, it is possible to avoid the situation shown in, e.g., FIG. 1E, where the candidate character string disappears.

As described above, according to the first embodiment, the word table stores each word input in past times. Also, the word list table stores a group of words input in past times as a word set which does not depend upon an input order. When a character string is inputted, an exact-match or partial-match word of an inputted character string is extracted from the word table, then a word list including the extracted word is acquired from the word list table, and a supplement candidate character string is displayed using the acquired word list. Therefore, it is possible to display a supplement candidate character string having the same word construction as the space separation character string inputted in the past, without concerning the word input order. As a result, operability of the input operation using the supplement candidates improves. Furthermore, it is possible to prevent disappearance of a candidate character string caused by difference of word input order.

### Second Embodiment

In the above described first embodiment, a word list is extracted regardless of the word input order and a supplement candidate character string is displayed. However, depending on an inputted word, too many supplement candidates are displayed, thus may cause poor visibility. To solve such problem, in the second embodiment, supplement candidates are narrowed down before being displayed.

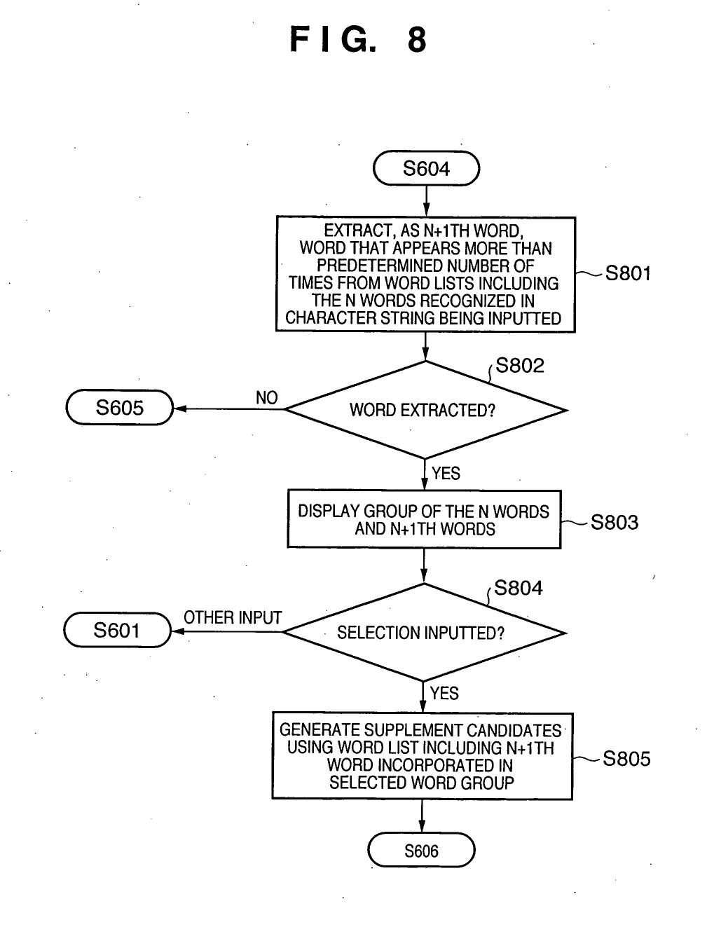

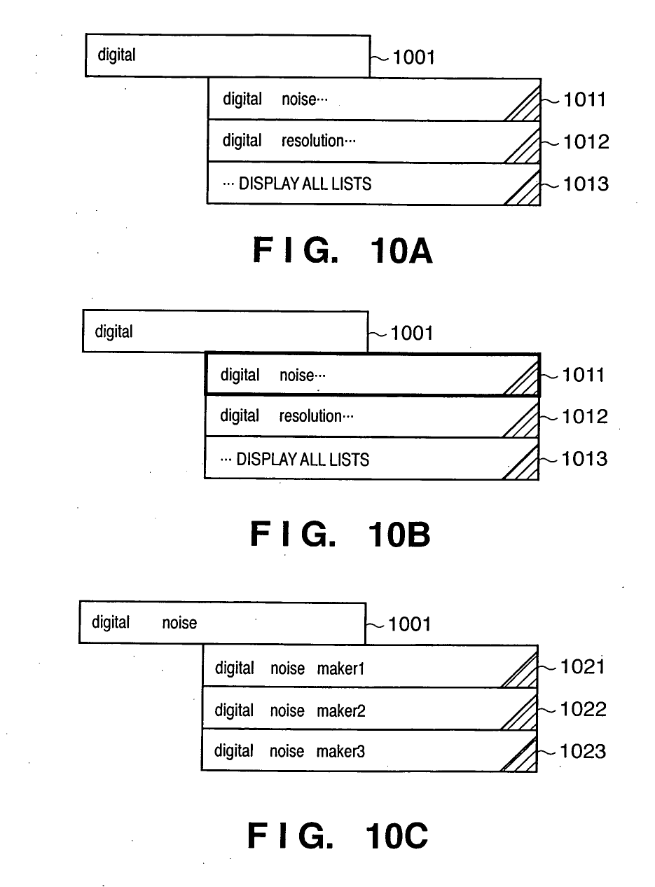

FIG. 8 is a flowchart describing the narrow-down processing of supplement candidates according to the second embodiment. Note that FIG. 8 is a process inserted between step S604 and S605 in FIG. 6. As mentioned above, in step S603 words are extracted from the character string being inputted (in the second embodiment, the words will be referred to as the N words (N is 1 or more)), and in step S604, word lists including the N words are extracted. In step S801, from the word lists including the N words extracted in step S604, a word that appears more than a predetermined number of times is extracted as N+1th word. The “predetermined number of times” which is the basis of extraction can be set externally by a user. If the N+1th word cannot be extracted, the control proceeds to step S605 to display a list of supplement candidate character strings as described in the first embodiment. If one or more N+1th words are extracted, the control proceeds to step S803, where the N words and a group of words extracted as the N+1th word are displayed (a detailed example will be described later with reference to FIG. 10A and the like).

After the display processing in step S803, if one is selected from the group of words, the control proceeds from step S804 to S805, and a supplement candidate character string is generated by the word list including the N+1th word in the selected group of words. More specifically, if the user inputs or selects one of the words extracted as the N+1th word, the word list including the N+1th word is used to generate a supplement candidate character string having the N+1th word at the beginning. Then, the control proceeds to step S606 to display the supplement candidate character string. Note that it is also possible to display the N+1th word in the aforementioned predetermined field at the point of selecting the N+1th word.

In a case where a character is inputted in the predetermined field after the display processing in step S803, the control returns from step S804 to S601. Thereafter, the above-described processing is repeated from step S601 with respect to the character string updated in the predetermined field.

After the display processing in step S803, in a case where numeral 1013 in FIG. 10A (display all lists) is designated, all the word lists including the N words may be displayed. Displaying all the lists can be executed by the above-described processing in steps S604 and S605. Although not shown in FIG. 8, when the user designates to display all lists in the display state of step S803, the control may proceed from step S804 to S605.

To determine the selection input in step S804, selection of the candidate character string 1011 or 1012 shown in FIG. 10A may be used, but it is not limited to this. For instance, selection input may be determined at the point of inputting a separation character (space) and an exact-match character string of one of the N+1th words. In this case, when a character string other than the N+1th word is inputted, the control immediately returns to step S601.

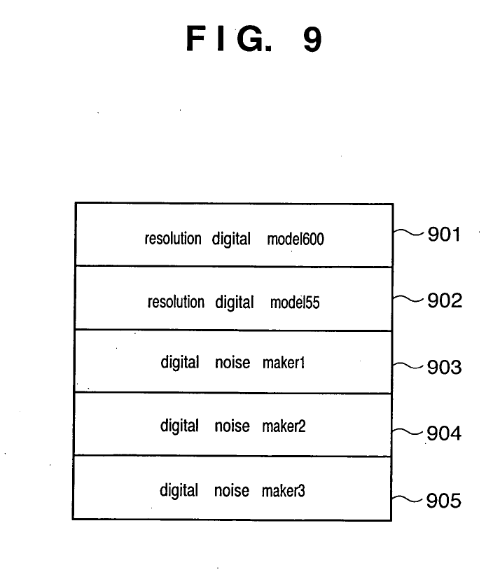

Next, a detailed example is described with reference to FIGS. 9 and 10A to 10C. Assume that the word lists 901 to 905 in FIG. 9 have already been registered in the word list table 300 and the word table 400 as input history data (illustration and description of the drawings are omitted).

When the text “digital” is inputted in the input field 1001 as shown in FIG. 10A, the word “digital” is extracted from the word table (step S603), and a word list including this word is extracted from the word list table (step S604). In this example, “digital” is extracted as the N word (in this case, N=1), and the word lists 901 to 905 in FIG. 9 are extracted. Next, from the extracted word lists, words having two or more number of arose times (the number of appeared times) are extracted as N+1th words (step S801). In the example in FIG. 9, “resolution” and “noise” are the N+1th words. The extracted N+1th words are displayed along with the word inputted in the input field 1001 (1011 and 1012) and the apparatus prompts for a user's selection (step S803). Note, it is also possible to simultaneously display the supplement candidate character strings generated based on the word lists extracted in accordance with the operation of the first embodiment. In the second embodiment, “display all lists” 1013 is exhibited to let the user decide whether or not to display the supplement candidate character strings according to the first embodiment.

In the display state shown in FIG. 10A, the user selects a desired N+1th word (step S804). For instance, the user can use a mouse for selecting a candidate character string including a desired word. In a case where numeral 1011 is selected as shown in FIG. 10B, the N word “digital”, which has been inputted in the input field 1001, and the N+1th word “noise” are automatically reflected in the input field 1001 as shown in FIG. 10C. Then, only the word lists including “digital” and “noise” are displayed as the supplement candidates (1021 to 1023) (step S805).

### Third Embodiment

Described in the third embodiment is processing for limiting the supplement candidate display in the above-described supplement candidate narrow-down processing of the second embodiment.

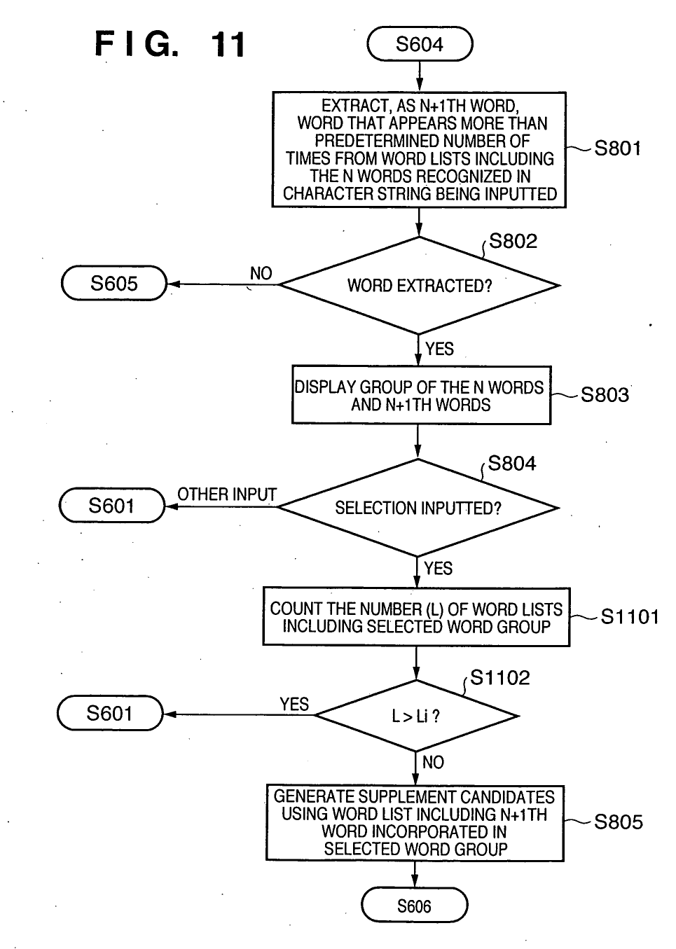

Processing of the third embodiment is described with reference to FIG. 11. The processing in FIG. 11 replaces the processing in FIG. 8 described in the second embodiment. In FIG. 11, to the steps similar to those of FIG. 8, the same reference numerals are assigned. Prior to executing the processing in FIG. 11, a limitation value Li which limits the number of supplement candidates to be displayed is set. The limitation value Li may be fixed or may arbitrarily be designated by a user.

As described in the second embodiment, in step S801, words whose number of appeared times exceeds a predetermined number of times are extracted, as the N+1th words, from the word list including the N words incorporated in the character string being inputted. When N+1th words are extracted, control proceeds from step S802 to S803. In step S803, the N words and a group of N+1th words are displayed. When one is selected from the group of words displayed, the control proceeds from step S804 to S1101, where the number (L) of word lists including the N+1th word is counted. The number (L) of word lists indicates the number of word lists that have been narrowed down by selection of the N+1th word.

Next, in step S1102, the number (L) of narrowed-down word lists counted in step S1101 is compared with the set limitation value Li indicative of the number of supplement candidate character strings to be displayed. If the number (L) of the word lists exceeds the limitation value Li (L>Li), the control is returned to step S601 to prompt a user for additional word input. In this stage, the user may be notified of the fact that the candidates of the word lists (space separation character strings) are not sufficiently narrowed down. Meanwhile, if the number (L) of the word lists does not exceed the limitation value Li (L≦Li), the control proceeds to step S805 where supplement candidates are constructed based on the extracted word lists and displayed. Then, the control ends.

As set forth above, the third embodiment performs list displaying in a case where the number of word lists is equal to or less than a predetermined number. Therefore, the visibility in list displaying can further be improved.

As has been set forth above, according to the above-described embodiments, in an input operation of a character string constructed with plural words whose order of designation serves no purpose, it is possible to eliminate an operational limitation that requires a user to input words in previously inputted order, and reduce the burden on the user.

The foregoing description has been provided as embodiments of the present invention. The present invention can be realized in the form of, e.g., a system, an apparatus, a method, a program, or a storage medium. More specifically, the present invention can be applied to a system constituted by a plurality of devices or to a stand-alone apparatus.

Note that the present invention includes a case where the functions of the above-described embodiments are achieved by directly or remotely supplying a software program to a computer system or apparatus, then reading the supplied program codes by a computer of the system or apparatus, and executing the program codes. In this case, the supplied program corresponds to the flowcharts in the drawing of the embodiments.

Therefore, the program codes themselves which are installed in a computer to realize the functions of the present invention using the computer also constitute the invention. In other words, the present invention includes the computer program itself for realizing the functions of the present invention.

In this case, as long as it functions as a program, the form of program codes may be of object codes, a program executed by an interpreter, script data supplied to an OS, or the like.

For a recording medium which supplies the program, for instance, a floppy (registered trademark) disk, a hard disk, an optical disk, a magneto-optical disk, MO, CD-ROM, CD-R, CD-RW, a magnetic tape, a non-volatile memory card, ROM, DVD (DVD-ROM, DVD-R) and the like can be used.

As another program supplying method, a home page on the Internet is accessed using a browser of a client computer, and a computer program according to the present invention can be downloaded from the homepage to a recording medium such as a hard disk. In this case, the downloaded program may be a compressed file including an automatic installation function. Furthermore, the program codes constituting the program according to the present invention may be divided into plural files, and each of the plural files may be downloaded from different home pages. In other words, the present invention also includes a WWW server which allows plural users to download the program file that realizes the functions of the present invention using a computer.

Furthermore, the program according to the present invention may be encrypted and stored in a storage medium, e.g., CD-ROM, for user distribution. In this case, a user who satisfies a predetermined condition is allowed to download decryption key data from a homepage on the Internet and execute the encrypted program using the key data to install the program in a computer.

Still further, besides aforesaid functions according to the above embodiments are realized by executing the program read by a computer, the functions according to the above embodiments can be realized in cooperation with an OS (operating system) or the like working on a computer in accordance with designations of the program. In this case, the OS or the like performs part or the entire processes, thereby realizing the functions of the above-described embodiments.

Furthermore, the program read from the recording medium may be written in a function expansion card which is inserted into the computer or in a memory provided in a function expansion unit which is connected to the computer, and part or all of the functions according to the above-described embodiments may be realized. In this case, after the program is written in the function expansion card or unit, a CPU or the like contained in the function expansion card or unit performs part or the entire processes in accordance with designations of the program.

According to the present invention, the burden of a user in a character string input operation is reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-241569, filed Aug. 23, 2005, which is hereby incorporated by reference herein in its entirety.

What is claimed is:

1. A character input aiding method in an information processing apparatus capable of inputting a character string constructed with plural words, comprising:
a registration step of registering a set of words in a memory, the set of words having as elements all words included in a character string which has been inputted to the information processing apparatus and confirmed;
an acquisition step of acquiring, from the set of words registered in said registration step, a set of words including an exact-match word or a partial-match word of a character string being inputted to the information processing apparatus; and
a generation step of generating a supplement candidate character string based on the set of words acquired in said acquisition step and exhibiting the supplement candidate character string.

2. The method according to claim 1, wherein the set of words including an exact-match word or a partial-match word is a set of words having a word whose part or entirety matches the character string being inputted regardless of an order of the words.

3. The method according to claim 1, further comprising a field display step of displaying a predetermined field on a display screen, wherein the character string which is inputted to the information processing apparatus is a character string inputted to the predetermined field.

4. The method according to claim 1, wherein in said generation step, among words included in the set of words acquired in said acquisition step, a word that exactly matches or partially matches the inputted character string is arranged in a order of the inputted character string, and a remaining word is added subsequently, with inserting a predetermined letter symbol between the words, thereby generating the supplement candidate character string.

5. The method according to claim 1, further comprising:
an extraction step of extracting, in a case where a plurality of sets of words are acquired in said acquisition step, a word other than the exact-match word or the partial-match word of the character string being inputted, whose number of appeared times in the plurality of sets of words is equal to or larger than a predetermined number of times; and
an exhibiting step of exhibiting a group of words consisting of the exact-match word or the partial-match word of the character string being inputted and a word extracted in said extraction step,
wherein in said generation step, among the set of words acquired in said acquisition step, the supplement candidate character string is generated using a set of words having all words of a group selected from the group of words exhibited in said exhibiting step.

6. The method according to claim 1, further comprising a determination step of determining whether or not the number of the set of words having all words of the group selected from the group of words exhibited in said exhibiting step exceeds a predetermined number,
wherein in a case where the number of the set of words is equal to or less than the predetermined number in said determination step, in said generation step, the supplement candidate character string is generated using the set of words having all words of the selected group.

7. An information processing apparatus capable of inputting a character string constructed with plural words, comprising:
a registration unit that registers a set of words in a memory, the set of words having as elements all words included in a character string which has been inputted to the information processing apparatus and confirmed;
an acquisition unit that acquires, from the set of words registered by said registration unit, a set of words including an exact-match word or a partial-match word of a character string being inputted to the information processing apparatus; and
a generation unit that generates a supplement candidate character string based on the set of words acquired by said acquisition unit and exhibits the supplement candidate character string.

8. A computer program which causes a computer to execute the method described in claim 1.

9. A computer-readable medium which stores the computer program described in claim 8.
